(19) United States
(12) Patent Application Publication
(10) Pub. No.: US 2026/0222789 A1
(43) Pub. Date: Jul. 30, 2026

(54) METHOD FOR OUT-OF-SERVICE (OOS) RECOVERY ON USER EQUIPMENT (UE) HAVING MULTIPLE SUBSCRIBER IDENTITY MODULES (SIMS)

(71) Applicant: MEDIATEK INC., Hsinchu City (TW)

(72) Inventors: Fong-Shih WEI, Hsinchu City (TW); Jia-Hao WU, Hsinchu City (TW); Da-Wei WANG, Hsinchu City (TW); Chia-Shing TAI, Hsinchu City (TW); Wei-Cheng LIN, Hsinchu City (TW); Tsung-Yu PENG, Hsinchu City (TW); Jia-Ling JIANG, Hsinchu City (TW); Ting-Guang YEN, Hsinchu City (TW); Wei-Jen CHEN, Hsinchu City (TW)

(21) Appl. No.: 19/448,488

(22) Filed: Jan. 14, 2026

Related U.S. Application Data
(60) Provisional application No. 63/749,012, filed on Jan. 24, 2025.

(51) Int. Cl. H04W 8/00; H04B 17/318; H04W 76/20; H04W 84/04

(52) U.S. Cl. CPC H04W 8/005; H04B 17/318; H04W 76/20; H04W 84/042

(57) ABSTRACT

A method for out-of-service (OOS) recovery on user equipment (UE) having a first subscriber identity module (SIM) and a second SIM is provided. The second SIM intends to perform the OOS recovery. The method includes the following steps. Searches for stored frequencies, full bands, and different radio access technologies (RAT) are scheduled based on different scenarios and the service type of the first SIM. The order of the stored frequencies, the full bands, and the RATs for the searches are prioritized based on the different scenarios and the service type of the first SIM.

### CROSS REFERENCE TO RELATED APPLICATIONS

This application claims the benefit of U.S. provisional application No. 63/749,012, filed on Jan. 24, 2025, the entirety of which is incorporated by reference herein.

### BACKGROUND OF THE INVENTION

### Field of the Invention

The present invention relates to user equipment (UE), and, in particular, it relates to a method for out-of-service (OOS) recovery on UE having multiple subscriber identity modules (SIMs).

### Description of the Related Art

An out-of-service (OOS) procedure is a method for a UE to search for a suitable cell to camp on in a network when the UE is powered on, or when it fails to establish a link with the network (that is, public land mobile network (PLMN) loss). The term “Multiple SIMs” refers to a feature that allows mobile devices, such as smartphones and tablets, to support the use of multiple distinct SIM cards simultaneously. Key performance indicators (KPI) of the OOS procedure for multiple SIMs includes power consumption, recovery search time, and ratio of interruption over the other distinct SIMs.

There being different scenarios, the use of an improper strategy for the procedure will degrade the KPI significantly. For example, a single SIM that intends to search all supported frequencies and bands to find suitable cells may interrupt the operation of other SIMs and use power unnecessarily when no signal is presented. A blind search by a SIM which intends to perform the OOS procedure will result in unnecessary power consumption and a long recovery time.

### BRIEF SUMMARY OF THE INVENTION

An embodiment of the present invention provides a method for out-of-service (OOS) recovery on user equipment (UE) having a first subscriber identity module (SIM) and a second SIM. The second SIM intends to perform the OOS recovery. The method includes the following steps. Searches for stored frequencies, full bands, and different radio access technologies (RAT) are scheduled based on different scenarios and the service type of the first SIM. The order of the stored frequencies, the full bands, and the RATs for the searches are prioritized based on the different scenarios and the service type of the first SIM.

According to the method described above, the step of scheduling the searches for the stored frequencies, the full bands, and the different RATs based on different scenarios and the service type of the first SIM includes the following steps. In response to the operators of the first SIM and the second SIM not being the same and the service type of the first SIM being a radio resource control (RRC) idle state, public land mobile network (PLMN) searches is performed sporadically using the first SIM.

According to the method described above, the step of sporadically performing the PLMN searches using the first SIM includes the following steps. The first SIM is enabled to enter an active state in response to the first SIM intending to perform radio resource management (RRM) or to receive paging information. The first SIM is enabled to enter an in-active state in response to the first SIM not needing to perform the RRM or to receive the paging information, and the second SIM not being at OOS. The first SIM is enabled to enter an assist-OOS search state to perform the PLMN searches in response to the second SIM intending to perform the OOS recovery and the first SIM being about to enter the in-active state.

According to the method described above, the step of scheduling the searches for the stored frequencies, the full bands, and the different RATs based on different scenarios and the service type of the first SIM includes the following steps. In response to the operators of the first SIM and the second SIM not being the same and the service type of the first SIM being a radio resource control (RRC) connected state, public land mobile network (PLMN) searches are performed on the stored frequencies, and full-band power scan (PS) and PLMN searches on all frequencies iteratively using the second SIM, or received signal strength indication (RSSI) sniffing is performed sporadically on all the stored frequencies using the second SIM, or the OOS recovery is stopped to prevent interruption over the first SIM using the second SIM.

According to the method described above, the step of performing the PLMN searches on the stored frequencies, and the full-band PS and PLMN searches on all frequencies iteratively using the second SIM, includes the following steps. The second SIM is enabled to enter an active-OOS state from an initialization in response to the UE failing to establish a link with a network, and the second SIM is enabled to reset the OOS period timer to a first value and reset the OOS duration timer to a second value. The second SIM is enabled to enter the active-OOS state from a stop-OOS state in response to the OOS period timer expiring, and the second SIM is enabled to reset the OOS period timer to the first value and reset the OOS duration timer to the second value. The previous state before the stop-OOS state is the active-OOS state. The second SIM is enabled to enter the active-OOS state from a passive-OOS state in response to the passive OOS timer expiring or the RSSI sniffing indicating that some frequency's metric exceeds a threshold.

According to the method described above, the step of sporadically performing the RSSI sniffing on all the stored frequencies using the second SIM includes the following steps. The second SIM is enabled to enter the passive-OOS state from the active-OOS state in response to a continued failure to identify a cell to camp on even for limited service and public warning system (PWS) service after completing the PLMN searches on the stored frequencies and the full-band PS and PLMN searches on all frequencies. The second SIM is enabled to enter the passive-OOS state from the stop-OOS state in response to the OOS period timer expiring, and the second SIM is enabled to reset the OOS period timer to the first value and reset the OOS duration timer to the second value. The previous state before the stop-OOS state is the passive-OOS state.

According to the method described above, the step of stopping the OOS recovery to prevent interruption over the first SIM using the second SIM includes the following steps. The second SIM is enabled to enter the stop-OOS state from the active-OOS state in response to execution of sub-functions in the active-OOS state being done and the OOS duration timer expiring with an enable duty cycle being true. The second SIM is enabled to enter the stop-OOS state from the passive-OOS state in response to execution of sub-functions in the passive-OOS state being done and the OOS duration timer expiring with an enable duty cycle being true.

According to the method described above, the step of performing the PLMN searches on the stored frequencies, and the full-band PS and PLMN searches on all frequencies iteratively using the second SIM includes the following steps. A first function is performed to gather information from the first SIM, check RRC and operator combo of the first SIM and the second SIM, and decide a duty cycle for the OOS recovery. A second function is performed to optimize the OOS recovery in the different scenarios, and modify relative parameters adaptively in the different scenarios. A third function is performed to perform the PLMN searches.

The method further includes the following steps. The second SIM is enabled to enter a registered state from the active-OOS state in response to detecting a suitable cell and being registered successfully. The second SIM is enabled to enter the active-OOS state from the registered state in response to losing connection to a network and failing at re-establishment in radio link failure (RLF).

According to the method described above, the step of scheduling the searches for the stored frequencies, the full bands, and the different RATs based on different scenarios and the service type of the first SIM includes the following steps. In response to the operators of the first SIM and the second SIM being the same or sharing a network, and the service type of the first SIM being a radio resource control (RRC) idle state or an RRC connected state, network information is shared with the second SIM to avoid radio frequency (RF) preemption by the second SIM.

According to the method described above, the step of scheduling the searches for the stored frequencies, the full bands, and the different RATs based on different scenarios and the service type of the first SIM includes the following steps. In response to the operators of the first SIM and the second SIM being the same or sharing a network, and the service type of the first SIM being an OOS state, the OOS recovery is performed using the first SIM to obtain a result, and sharing the result with the second SIM.

According to the method described above, the step of scheduling the searches for the stored frequencies, the full bands, and the different RATs based on different scenarios and the service type of the first SIM includes the following steps. In response to the operators of the first SIM and the second SIM not being the same and the service type of the first SIM being an OOS state, joint band searches on the stored frequencies of both the first and second SIMs with highest priority are performed. The joint band searches take both the first and second SIMs into consideration.

According to the method described above, the step of scheduling the searches for the stored frequencies, the full bands, and the different RATs based on different scenarios and the service type of the first SIM includes the following steps. In response to the operators of the first SIM and the second SIM not being the same, the service type of the first SIM being a radio resource control (RRC) connected state, and the first SIM performing a call service, only an OOS recovery that is capable of dual reception (DR) is performed during the call service.

According to the method described above, the step of scheduling the searches for the stored frequencies, the full bands, and the different RATs based on different scenarios and the service type of the first SIM includes the following steps. In response to the operators of the first SIM and the second SIM not being the same, the service type of the first SIM being a radio resource control (RRC) connected state, and the first SIM gaming or playing video, searches are decimated in time instead of stopping low priority RAT searches or full-band searches. A frequency list is reordered and control of the searches is adjusted adaptively.

According to the method described above, the step of prioritizing the order of the stored frequencies, the full bands, and the RATs for the searches based on the different scenarios and the service type of the first SIM includes the following step. A frequency among the stored frequencies that was camped on last, or measured from inter-measurement, or preference frequency, or registered public land mobile network (RPLMN) for roaming, or home PLMN (HPLMN) for roaming, or equivalent HPLMN (EHPLMN) for roaming is defined as high priority. A frequency among the stored frequencies that is detected from a weak cell or removed from the high priority is defined as middle priority. All other frequencies that do not belong to the high priority and middle priority are defined as low priority.

An embodiment of the present invention also provides user equipment (UE). The UE includes a first SIM, a second SIM, and a processor. The second SIM intends to perform the OOS recovery. The processor is electrically coupled the first SIM and the second SIM. The processor schedules searches for stored frequencies, full bands, and different radio access technologies (RAT) based on different scenarios and the service type of the first SIM. The processor prioritizes the order of the stored frequencies, the full bands, and the RATs for the searches based on the different scenarios and the service type of the first SIM.

According to the UE described above, in response to the operators of the first SIM and the second SIM not being the same and the service type of the first SIM being a radio resource control (RRC) idle state, the processor sporadically performs public land mobile network (PLMN) searches using the first SIM.

According to the UE described above, the processor enables the first SIM to enter an active state in response to the first SIM intending to perform radio resource management (RRM), or it receives paging information. The processor enables the first SIM to enter an in-active state in response to the first SIM not needing to perform the RRM or to receive the paging information, and the second SIM not being at OOS. The processor enables the first SIM to enter an assist-OOS search state to perform the PLMN searches in response to the second SIM intending to perform the OOS recovery and the first SIM being about to enter the in-active state.

According to the UE described above, in response to the operators of the first SIM and the second SIM not being the same and the service type of the first SIM being a radio resource control (RRC) connected state, the processor performs the following actions. The processor performs public land mobile network (PLMN) searches on the stored frequencies, and full-band power scan (PS) and PLMN searches on all frequencies iteratively using the second SIM. Alternatively, the processor sporadically performs received signal strength indication (RSSI) sniffing on all the stored frequencies using the second SIM. Alternatively, the processor stops the OOS recovery to prevent interruption over the first SIM using the second SIM.

According to the UE described above, in response to the operators of the first SIM and the second SIM not being the same and the service type of the first SIM being a radio resource control (RRC) connected state, the processor performs the following actions. The processor enables the second SIM to enter an active-OOS state from an initialization in response to the UE failing to establish a link with a network, and enables the second SIM to reset the OOS period timer to a first value and reset the OOS duration timer to a second value. The processor enables the second SIM to enter the active-OOS state from a stop-OOS state in response to the OOS period timer expiring, and enables the second SIM to reset the OOS period timer to the first value and reset the OOS duration timer to the second value. The previous state before the stop-OOS state is the active-OOS state. The processor enables the second SIM to enter the active-OOS state from a passive-OOS state in response to the passive OOS timer expiring or the RSSI sniffing indicating that some frequency's metric exceeds a threshold.

According to the UE described above, the processor enables the second SIM to enter the passive-OOS state from the active-OOS state in response to a continued failure to identify a cell to camp on even for limited service and public warning system (PWS) service after completing the PLMN searches on the stored frequencies and the full-band PS and PLMN searches on all frequencies. The processor enables the second SIM to enter the passive-OOS state from the stop-OOS state in response to the OOS period timer expiring, and enables the second SIM to reset the OOS period timer to the first value and reset the OOS duration timer to the second value. The previous state before the stop-OOS state is the passive-OOS state.

According to the UE described above, the processor enables the second SIM to enter the stop-OOS state from the active-OOS state in response to execution of sub-functions in the active-OOS state being done and the OOS duration timer expiring with an enable duty cycle being true. The processor enables the second SIM to enter the stop-OOS state from the passive-OOS state in response to execution of sub-functions in the passive-OOS state being done and the OOS duration timer expiring with an enable duty cycle being true.

According to the UE described above, the processor performs a first function to gather information from the first SIM, checks RRC and operator combo of the first SIM and the second SIM, and decides a duty cycle for the OOS recovery. The processor performs a second function to optimize the OOS recovery in the different scenarios, and modifies relative parameters adaptively in the different scenarios. The processor performs a third function to perform the PLMN searches.

According to the UE described above, the processor enables the second SIM to enter a registered state from the active-OOS state in response to detecting a suitable cell and being registered successfully. The processor enables the second SIM to enter the active-OOS state from the registered state in response to losing connection to a network and failing at re-establishment in radio link failure (RLF).

According to the UE described above, the processor shares network information with the second SIM to avoid radio frequency (RF) preemption by the second SIM in response to the operators of the first SIM and the second SIM being the same or sharing a network, and the service type of the first SIM being a radio resource control (RRC) idle state or an RRC connected state.

According to the UE described above, the processor performs the OOS recovery using the first SIM to obtain a result and share the result with the second SIM in response to the operators of the first SIM and the second SIM being the same or sharing a network, and the service type of the first SIM being an OOS state.

According to the UE described above, the processor performs joint band searches on the stored frequencies of both the first and second SIMs with high priority in response to the operators of the first SIM and the second SIM not being the same and the service type of the first SIM being an OOS state. The joint band searches take both the first and second SIMs into consideration.

According to the UE described above, the processor only performs an OOS recovery that is capable of dual reception (DR) during the call service in response to the operators of the first SIM and the second SIM not being the same, the service type of the first SIM being a radio resource control (RRC) connected state, and the first SIM performing a call service.

According to the UE described above, in response to the operators of the first SIM and the second SIM not being the same, the service type of the first SIM being a radio resource control (RRC) connected state, and the first SIM gaming or playing video, the processor performs the following steps. The processor decimates searches in time instead of stopping low priority RAT searches or full-band searches. The processor reorders a frequency list and adaptively adjusts control of the searches.

According to the UE described above, the processor defines a frequency among the stored frequencies that was camped on last, or measured from inter-measurement, or preference frequency, or registered public land mobile network (RPLMN) for roaming, or home PLMN (HPLMN) for roaming, or equivalent HPLMN (EHPLMN) for roaming as high priority. The processor defines a frequency among the stored frequencies that is detected from a weak cell or removed from the high priority as middle priority. The processor defines all other frequencies that do not belong to the high priority and middle priority as low priority.

### BRIEF DESCRIPTION OF THE DRAWINGS

The present invention can be more fully understood by reading the subsequent detailed description and examples with references made to the accompanying drawings.

FIG. 1 is a flow chart of a method for out-of-service (OOS) recovery on user equipment (UE) having a first subscriber identity module (SIM) and a second SIM in accordance with some embodiments of the present invention.

FIG. 2 is a flow chart of a method for OOS recovery on the UE having the first SIM and the second SIM in accordance with some embodiments of the present invention.

FIG. 3 is a schematic diagram of a state transition of the first SIM in response to the first SIM being at a radio resource control (RRC) idle state and the second SIM being at an OOS in accordance with some embodiments of the present invention.

FIG. 4 is a schematic diagram of a state transition of the second SIM in response to the first SIM being at an RRC connected state and the second SIM being at the OOS in accordance with some embodiments of the present invention.

FIG. 5 is a timing diagram of the second SIM performing and stopping an OOS recovery alternately in accordance with some embodiments of the present invention.

FIG. 6 is a timing diagram of the state transition of the second SIM in response to the first SIM being at the RRC connected state and the second SIM being at the OOS in accordance with some embodiments of the present invention.

FIG. 7 is a schematic diagram of user equipment 700 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

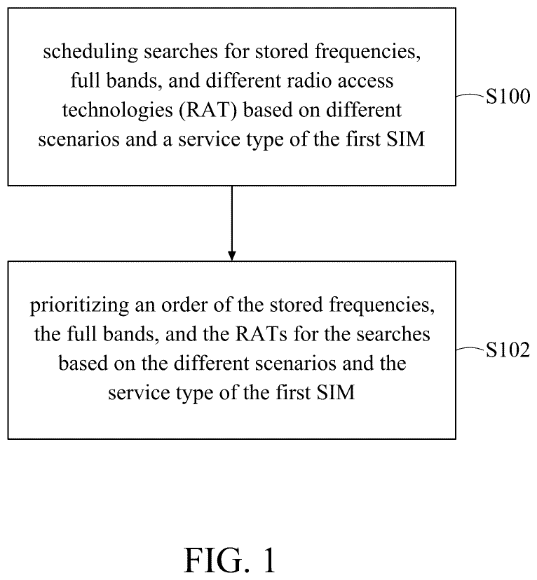

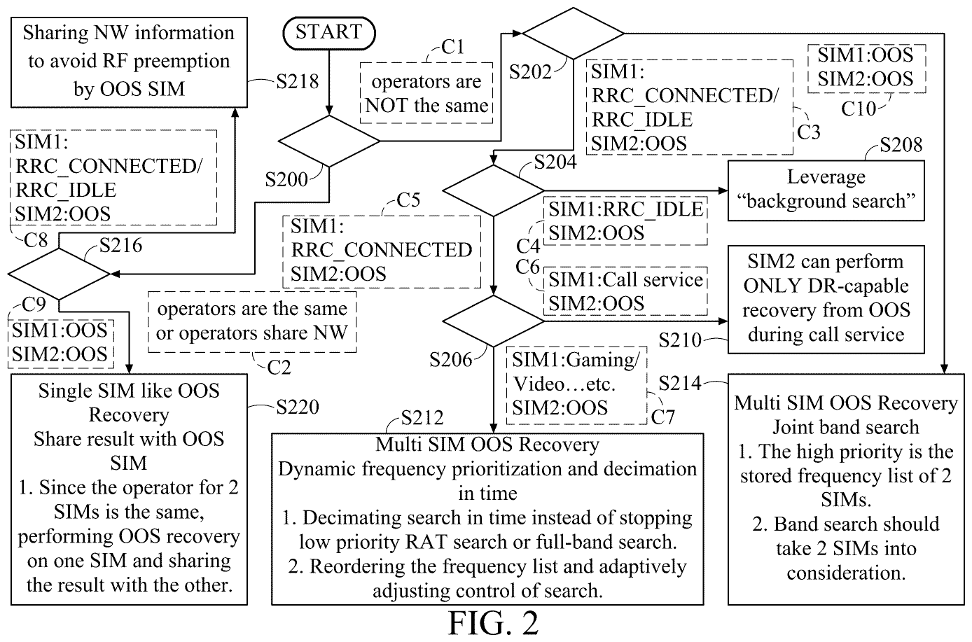

FIG. 1 is a flow chart of a method for out-of-service (OOS) recovery on user equipment (UE) having a first subscriber identity module (SIM) and a second SIM in accordance with some embodiments of the present invention. The second SIM intends to perform the OOS recovery. As shown in FIG. 1, the method for OOS recovery of the present invention includes the following steps. Searches for stored frequencies, full bands, and different radio access technologies (RAT) are scheduled based on different scenarios and the service type of the first SIM (step S100). The order of the stored frequencies, the full bands, and the RATs for the searches are prioritized based on the different scenarios and the service type of the first SIM (step S102). A detailed description of steps S100 and S102 is disclosed in the following FIG. 2.

FIG. 2 is a flow chart of a method for OOS recovery on the UE having the first SIM and the second SIM in accordance with some embodiments of the present invention. The service type of the second SIM (for example, SIM 2 in FIG. 2) is an OOS state. As shown in FIG. 2, in step S200, the method of the present invention determines whether operators of the first SIM (for example, SIM 1 in FIG. 2) and the second SIM are the same or not. Condition C1 is met in response to the operators of the first SIM and the second SIM not being the same. Alternatively, condition C2 is met in response to the operators of the first SIM and the second SIM being the same or the operators of the first SIM and the second SIM sharing a network. When condition C1 is met, in step S202, the method of the present invention determines whether the service type of the first SIM being a radio resource control (RRC) idle state or an RRC connected state or an OOS state. Condition C3 is met in response to the service type of the first SIM being the RRC idle state or the RRC connected state. Alternatively, condition C10 is met in response to the service type of the first SIM being the OOS state.

When condition C3 is met, in step S204, the method of the present invention determines whether the service type of the first SIM being the RRC idle state or the RRC connected state. When condition C10 is met, in step S214, the method of the present invention performs multi-SIM OOS recovery. For example, the method of the present invention performs joint band searches on the stored frequencies of both the first and second SIMs with highest priority. The joint band searches take both the first and second SIMs into consideration.

Condition C4 is met in response to the service type of the first SIM being the RRC idle state. Condition C5 is met in response to the service type of the first SIM being the RRC connected state. When condition C4 is met, the method of present invention leverages “background search”. For example, in some embodiments, the present invention sporadically performing public land mobile network (PLMN) searches using the first SIM. When condition C5 is met, in step S206, the method of the present invention determines whether the first SIM performs a call service or not. Condition C6 is met in response to the first SIM performs the call service. Condition C7 is met in response to the first SIM perform gaming or plays video.

When condition C6 is met, in step S210, the method of the present invention only performs an OOS recovery that is capable of dual reception (DR) during the call service. When condition C7 is met, the method of present invention performs multi-SIM OOS recovery. For example, the method of present invention decimates searches in time instead of stopping low priority RAT searches or full-band searches, and reorders a frequency list and adaptively adjusts control of the searches.

When condition C2 is met, in step S216, the method of the present invention determines whether the service type of the first SIM is the radio RRC connected state or the OOS state. Condition C8 is met in response to the service type of the first SIM being the RRC connected state or the RRC idle state. Condition C9 is met in response to the service type of the first SIM being the OOS state. When condition C8 is met, in step S218, the method of the present invention shares network information with the second SIM to avoid radio frequency (RF) preemption by the second SIM. When condition C9 is met, in step S220, the method of the present invention performs a single-SIM like OOS recovery. For example, the method of the present invention performs the OOS recovery using the first SIM to obtain a result, and shares the result with the second SIM.

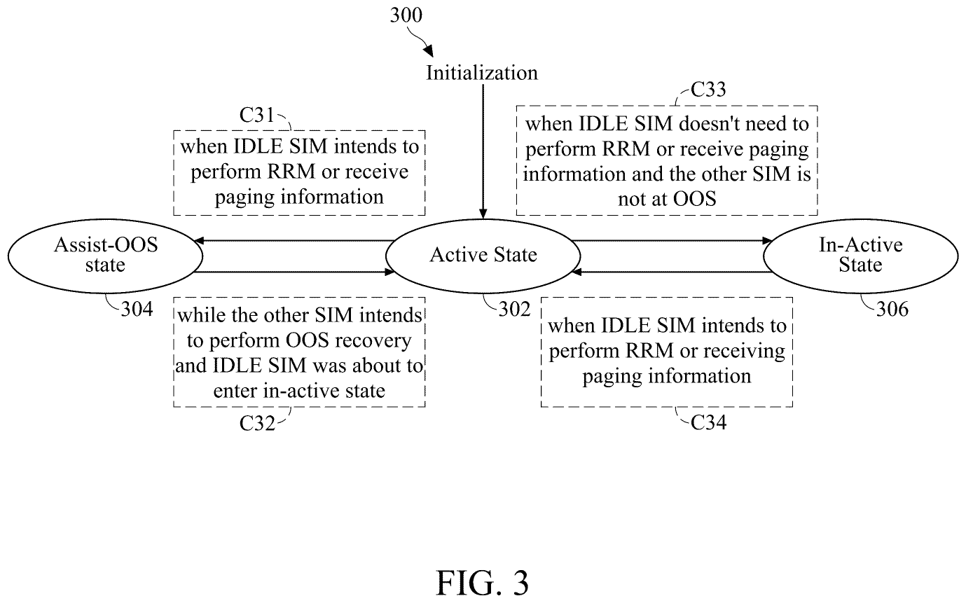

FIG. 3 is a schematic diagram of a state transition of the first SIM in response to the first SIM being at a radio resource control (RRC) idle state and the second SIM being at an OOS in accordance with some embodiments of the present invention. As shown in FIG. 3, the first SIM enters an active state 302 from an initialization 300. Condition C31 is met in response to the first SIM originally being at an assist-OOS search state 304 and intending to perform radio resource management (RRM) or to receive paging information. The method of present invention enables the first SIM to enter the active state 302 in response to condition C31 is met. Condition C34 is met in response to the first SIM originally being at an in-active state 306 and intending to perform the RRM or to receive the paging information. The method of present invention enables the first SIM to enter the active state 302 in response to condition C34 is met.

Condition C33 is met in response to the first SIM not needing to perform the RRM or to receive the paging information and the second SIM not being at OOS. The method of present invention enables the first SIM to enter the in-active state 306 from the active state 302 in response to condition C33 is met. Condition C32 is met in response to the second SIM intending to perform the OOS recovery and the first SIM being about to enter the in-active state 306. The method of present invention enables the first SIM to enter the assist-OOS search state 304 from the active state 302 to perform the PLMN searches in response to condition C32 is met.

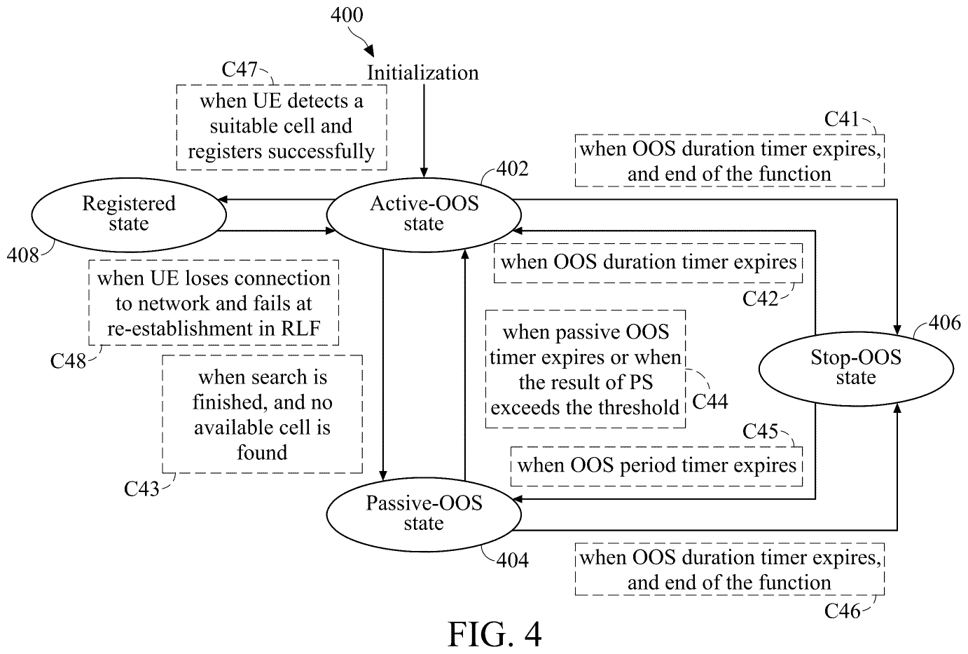

FIG. 4 is a schematic diagram of a state transition of the second SIM in response to the first SIM being at an RRC connected state and the second SIM being at the OOS in accordance with some embodiments of the present invention. In response to the operators of the first SIM and the second SIM not being the same and the service type of the first SIM being the RRC connected state, the method of present invention performs public land mobile network (PLMN) searches on the stored frequencies, and full-band power scan (PS) and PLMN searches on all frequencies iteratively using the second SIM.

For example, the method of the present invention enables the second SIM to enter an active-OOS state 402 from an initialization 400 in response to the UE failing to establish a link with a network, and enables the second SIM to reset the OOS period timer to a first value (for example, a value OOS_WORK_PRD) and reset the OOS duration timer to a second value (for example, a value OOS_WORK_DURATION). The method of the present invention enables the second SIM to enter the active-OOS state 402 from a stop-OOS state 406 in response to the OOS period timer expiring (that is, condition C42 is met), and enables the second SIM to reset the OOS period timer to the first value and reset the OOS duration timer to the second value. The previous state before the stop-OOS state 406 is the active-OOS state 402. The method of the present invention enables the second SIM to enter the active-OOS state 402 from a passive-OOS state 404 in response to the passive OOS timer expiring or the RSSI sniffing indicating that some frequency's metric exceeds a threshold (that is, condition C44 is met). In some embodiments, some frequency's metric may include the result of power scan (PS).

Alternatively, in response to the operators of the first SIM and the second SIM not being the same and the service type of the first SIM being the RRC connected state, the method of present invention sporadically performs received signal strength indication (RSSI) sniffing on all the stored frequencies using the second SIM. For example, the method of present invention enables the second SIM to enter the passive-OOS state 404 from the active-OOS state 402 in response to a continued failure to identify a cell to camp on even for limited service and public warning system (PWS) service after completing the PLMN searches on the stored frequencies and the full-band PS and PLMN searches on all frequencies (that is, condition C43 is met). The method of present invention enables the second SIM to enter the passive-OOS state 404 from the stop-OOS state 406 in response to the OOS period timer expiring (that is, condition C45 is met), and enables the second SIM to reset the OOS period timer to the first value and reset the OOS duration timer to the second value. The previous state before the stop-OOS state 406 is the passive-OOS state 404.

Alternatively, in response to the operators of the first SIM and the second SIM not being the same and the service type of the first SIM being the RRC connected state, the method of present invention stops the OOS recovery to prevent interruption over the first SIM using the second SIM. For example, the method of the present invention enables the second SIM to enter the stop-OOS state 406 from the active-OOS state 402 in response to execution of sub-functions in the active-OOS state 402 being done and the OOS duration timer expiring with an enable duty cycle being true (that is, condition C41 is met). The method of the present invention enables the second SIM to enter the stop-OOS state 406 from the passive-OOS state 404 in response to execution of sub-functions in the passive-OOS state 406 being done and the OOS duration timer expiring with an enable duty cycle being true (that is, condition C46 is met).

In some embodiments of FIG. 4, the method of the present invention enables the second SIM to enter a registered state 408 from the active-OOS state 402 in response to detecting a suitable cell and being registered successfully (that is, condition C47 is met). The method of the present invention enables the second SIM to enter the active-OOS state 402 from the registered state 408 in response to losing connection to a network and failing at re-establishment in radio link failure (RLF) (that is, condition C48 is met).

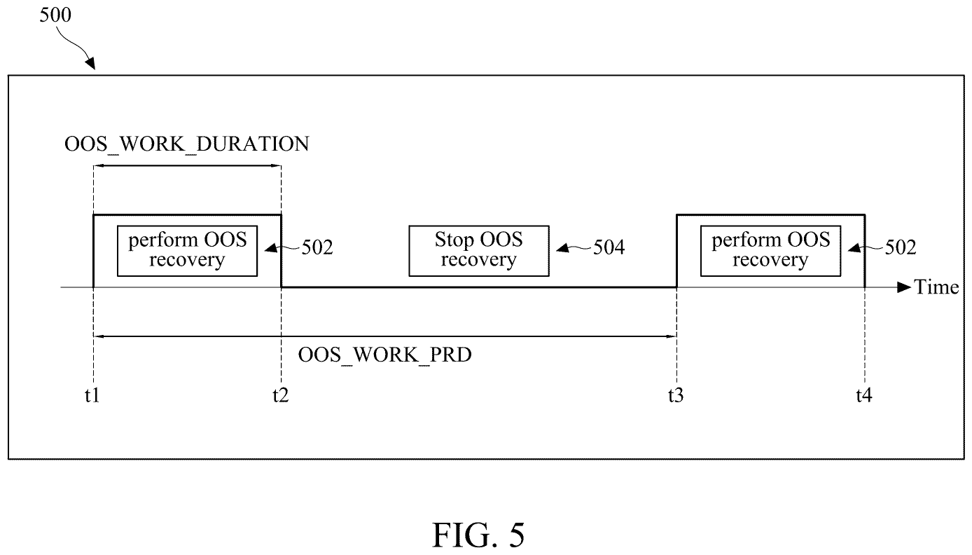

FIG. 5 is a timing diagram 500 of the second SIM performing and stopping an OOS recovery alternately in accordance with some embodiments of the present invention. As shown in FIG. 5, the method of present invention enables the second SIM to perform OOS recovery between a time point t1 and a time point t2, and between a time point t3 and a time point t4. The period between the time points t1 and t2 is equal to the value OOS_WORK_DURATION, which is set in the OOS duration timer when the second SIM enters the active-OOS state 402 from the initialization 400 or the stop-OOS state 406, or when the second SIM enters the passive-OOS state 404 from the stop-OOS state 406. Furthermore, the method of the present invention enables the second SIM to stop OOS recovery between the time point t2 and the time point t3. The period between the time points t1 and t3 is equal to the value OOS_WORK_PRD, which is set in the OOS period timer when the second SIM enters the active-OOS state 402 from the initialization 400 or the stop-OOS state 406, or when the second SIM enters the passive-OOS state 404 from the stop-OOS state 406.

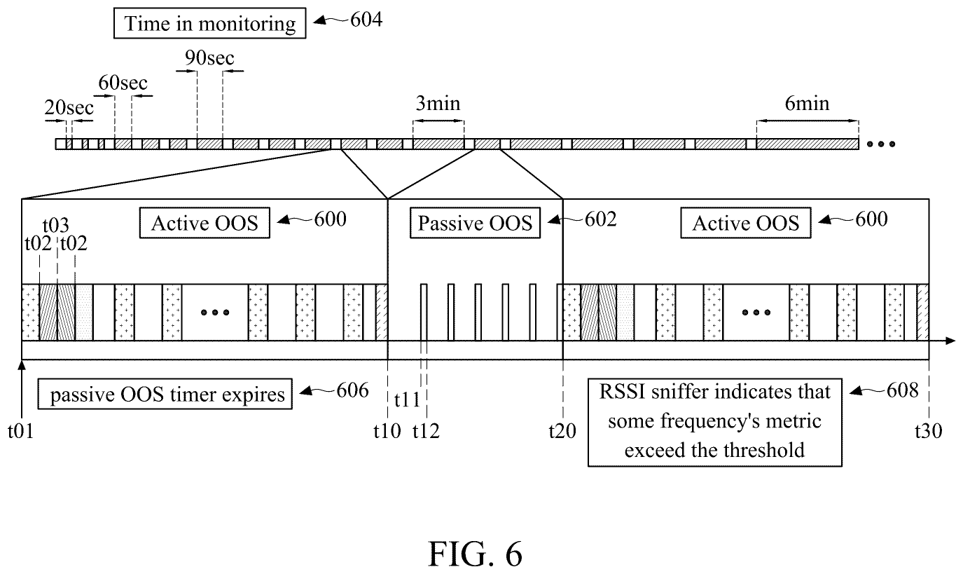

FIG. 6 is a timing diagram of the state transition of the second SIM in response to the first SIM being at the RRC connected state and the second SIM being at the OOS in accordance with some embodiments of the present invention. As shown in FIG. 6, based on time in monitoring 604, the method of the present invention enables the second SIM to switch between an active-OOS 600 state and a passive-OOS state 602 alternatively, and the period when the second SIM being at the passive-OOS state 602 become longer and longer during OOS recovery. For example, the period when the second SIM being at the passive-OOS state may increase from 20 seconds, 60 seconds, 90 seconds, 3 minutes to 6 minutes, but the present invention is not limited thereto.

In detail, the method of present invention enables the second SIM to enter the active-OOS state 600 between a time point t01 and a time point t10, and between a time point t20 and a time point t30. The method of present invention enables the second SIM to enter the passive-OOS state 602 between the time point t10 and the time point t20. At the time point t01, the passive-OOS timer expires. Between the time point t01 and a time point t02, the method of present invention enables the second SIM to search on all stored frequencies. Between the time point t02 and a time point t03, the method of present invention enables the second SIM to search on frequencies related to the operator. Between the time point t03 and a time point t04, the method of present invention enables the second SIM to search on frequencies of mobile country code (MCC) band based on location. Between the time point t04 and the time point t10, the method of present invention enables the second SIM to perform full-band power scan one time, and perform full-band PLMN searches and stored frequencies alternatively, and finally search for limited service or PWS service.

The method of present invention enables the second SIM to sporadically perform received signal strength indication (RSSI) sniffing on all the stored frequencies using the second SIM. For example, the second SIM is enabled to perform RSSI sniffing on all the stored frequencies between a time point t11 and a time point t12. At the time point t20, the RRSI sniffing indicates that some frequency's metric exceed the threshold.

When the second SIM is at the active-OOS state 600, the method of the present invention performs a first function (for example, a function LOAD_FROM_PEER_SIM) to gather information from the first SIM, checks RRC and operator combo of the first SIM and the second SIM, and decides a duty cycle for the OOS recovery. The method of the present invention performs a second function (for example, a function LOAD_SCENARIO_PARAMETERS) to optimize the OOS recovery in the different scenarios, and modify relative parameters adaptively in the different scenarios. The method of the present invention performs a third function (for example, a function SEARCH_FOR_PLMN_AMONG_FREQ) to perform the PLMN searches.

When the second SIM is at the entry of the active-OOS state 600, the function LOAD_FROM_PEER_SIM, the function LOAD_SCENARIO_PARAMETERS, and the function SEARCH_FOR_PLMN_AMONG_FREQ are triggered. The function SEARCH_FOR_PLMN_AMONG_FREQ includes power scan, cell search, cell measurement on all stored frequencies and full-band, if needed.

In some embodiments, when the second SIM is at the entry of the passive-OOS state 602, the method of the present invention enables the second SIM to reset the passive OOS timer to a value PASSIVE_OOS_PRD and a sleep timer as a value SLEEP_PRD. In some embodiments, the value PASSIVE_OOS_PRD is a function of the duration that UE staying in out-of-sync. It would increase as time elapse. In some embodiments, when the sleep timer expires, the method of the present invention performs both power scan (PS) and cell search (CS) for New Radio (NR), and performs power scan for the other RATs on all stored frequency. The corresponding codes are shown below.

```
if (2 SIMs are out-of-service)
  PS/CS on all integrated stored frequencies for 2 SIMs;
else
  PS/CS on all stored frequencies for one SIM;
if (the metric measured by PS (LTE) or CS (NR) on any frequency
exceeds the threshold)
next_state = active-OOS state;
  else
reset sleep_timer to SLEEP_PRD and enter sleep mode to save
power.
```

In some embodiments, when the passive OOS timer expires, the method of the present invention set the next state as the active-OOS state.

The codes of the function LOAD_FROM_PEER_SIM are shown below.

```
Reset OOS_WORK_DURATION, OOS_WORK_PRD to default value;
if (Dual SIM mode is ON) {
  if (SIM1 operator == SIM2 operator ||
  SIM1 and SIM2 share the same NW) {
    if (any SIM is RRC_IDLE or RRC_CONNECTED) [symbol]   {
      Proceed to camp on the cell as non-OOS SIM does;
      Exit OOS Recovery;
    }
} else {
  if (any SIM is RRC_IDLE) {
    if (a frequency pass CM-PBCH criterion)
      Try to camp on;
    Exit OOS Recovery;
  }
  }
}.
```

[symbol] : The present invention considers RRC_INACTIVE as RRC_IDLE. The present invention only considers the sharing between SIMs. The present invention can improve the mechanism by taking network traffic into consideration.

The codes of the function LOAD_SCENARIO_PARAMETERS are shown below.

```
Reset OOS_WORK_DURATION, OOS_WORK_PRD to default value; [symbol]
Reset DEC_STORED_PRD, DEC_FULL_PRD, PASSIVE_OOS_PRD and SLEEP_PRD to
default value;
Set en_duty_cycle = 0;
Set en_2G_3G_search = 0;
Similar_flag = Link_Tracking(*);
Adjustment_for_Duty_Cycle(* scenario indicators, e.g., Weak [symbol]  , Similar_flag);
Adjustment_for_On_Duration(* scenario indicators);
if (Dual SIM mode is ON && any SIM is RRC_CONNECTED) {
  Reduce_Low_Priority_RAT_Search(* scenario indicators);
  DEC_STORED_PRD and DEC_FULL_PRD = (DEC_STORED_PRD and
DEC_FULL_PRD) × 4;
  SLEEP PRD = SLEEP PRD × 3;
  PASSIVE_OOS_PRD = PASSIVE_OOS_PRD × 2;
}.
```

[symbol] : These parameters are to control the duty cycle of OOS recovery as shown in FIG. 5. For example, default OOS_WORK_DURATION is set as 400 ms. Default OOS_WORK_PRD is set as 1000 ms.

[symbol] : The present invention determines whether UE is entering weak field via tracking RSSI.

The codes of the function SEARCH_FOR_PLMN_AMONG_FREQ are shown below.

```
L1_Window_Reduction(*);
If ( mod(search counter, DEC_STORED_PRD) == 0 || the metric measured by PS (LTE) or
CS (NR) on any frequency exceeds the threshold in Passive-OOS state) {
Part A -----------------------------------------------------------------------------------
  if (2 SIMs are out-of-service)
    PLMN search(*) on all integrated stored frequencies for 2 SIM;
  else
    PLMN search(*) on all stored frequencies for one SIM;
Part A -------------------------------------------------------------------------------------
  if (2 SIMs are out-of-service)
    PLMN search( ) on all integrated operator-relative + stored frequencies for 2 SIM;
  else
    PLMN search( ) on all operator-relative for one SIM;
  if (2 SIMs are out-of-service)
    PLMN search( ) on all integrated MCC for 2 SIM;
} else {
Part B-------------------------------------------------------------------------------------
  if (2 SIMs are out-of-service)
    PLMN search( ) on all integrated high priority frequencies for 2 SIM;
  else
    PLMN search( ) on all high priority frequencies for one SIM;
Part B-------------------------------------------------------------------------------------
}
Re_Order_Stored_Frequency (*);
```

The codes among part A are searches for all stored frequency. The codes among part B are searches for only high priority frequencies. The codes among part A and the codes among part B may correspond to the period between the time point t01 and the time point t04 in FIG. 6.

In some embodiments, the method of present invention defines a frequency among the stored frequencies that was camped on last, or measured from inter-measurement, or preference frequency, or registered public land mobile network (RPLMN) for roaming, or home PLMN (HPLMN) for roaming, or equivalent HPLMN (EHPLMN) for roaming as high priority. The present invention defines a frequency among the stored frequencies that is detected from a weak cell or removed from the high priority as middle priority. The present invention defines all other frequencies that do not belong to the high priority and middle priority as low priority.

The codes of the function SEARCH_FOR_PLMN_AMONG_FREQ are further shown below.

```
Clear sub-band group list;
If (stop full-band search == 0 && mod(search counter, DEC_FULL_PRD) == 0 ) {
  Do {
Part C-------------------------------------------------------------------------------------
    if (sub-band group list is empty) {
      Perform full-band Power Scan on all supported frequencies;
      Sort the frequencies which exceeds threshold and divide them into sub-band
group and add into the sub-band group list;
    }
Part C-------------------------------------------------------------------------------------
Part D-------------------------------------------------------------------------------------
    if (2 SIMs are out-of-service)
      PLMN search( ) on all frequencies within the first sub-band group in the list
for 2 SIM;
    else
      PLMN search( ) on all frequencies within the first sub-band group in the list
for one SIM;
    if (a cell which exceeds the pre-defined threshold and register successfully)
      next-state=NW-Registered State;
    else
      Remove the first sub-band group from the list;
Part D-------------------------------------------------------------------------------------
Part E-------------------------------------------------------------------------------------
    if (2 SIMs are out-of-service)
      PLMN search(*) on all integrated stored frequencies for 2 SIM;
    else
      PLMN search( ) on all stored frequencies for one SIM;
Part E-------------------------------------------------------------------------------------
    } While (sub-band group list is not empty)
  }
search counter ++;
```

The codes among part C are for a one shot power scan. The band coverage for full-band power scan shall consider all hardware capability. The codes among part D are for a joint band search. The codes among part E are for all stored frequencies searches. The codes among parts C, D and E may correspond to the period between the time point t04 and the time point t10 in FIG. 6.

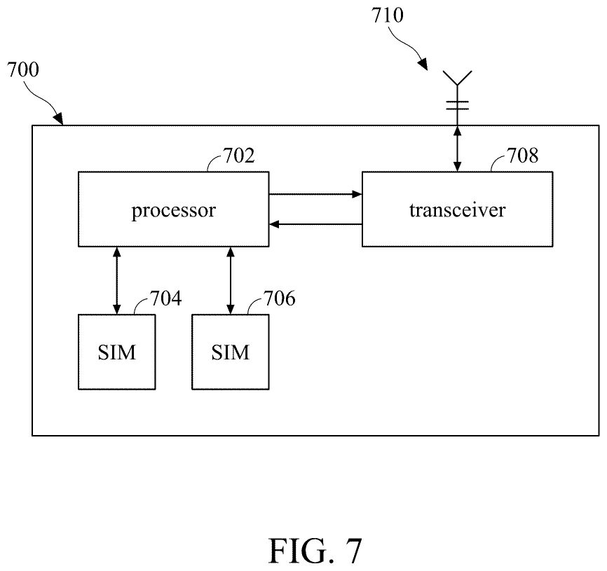

FIG. 7 is a schematic diagram of user equipment 700 in accordance with some embodiments of the present invention. As shown in FIG. 7, the UE 700 includes a processor 702, a SIM 704, a SIM 706, a transceiver 708, and an antenna 710. The processor 702 is electrically coupled to the SIM 704 and the SIM 706. The transceiver 708 is electrically coupled between the processor 702 and the antenna 710. The SIM 706 intends to perform the OOS recovery. The transceiver 708 receives or transmits radio signals through the antenna 710. The processor 702 schedules searches for stored frequencies, full bands, and different RATs based on different scenarios and the service type of the SIM 704. The processor 702 prioritizes the order of the stored frequencies, the full bands, and the RATs for the searches based on the different scenarios and the service type of the SIM 704.

In some embodiments, in response to the operators of the SIM 704 and the SIM 706 not being the same and the service type of the SIM 704 being an RRC idle state, the processor 702 sporadically performs PLMN searches using the SIM 704. In detail, the processor 702 enables the SIM 704 to enter an active state in response to the SIM 704 intending to perform RRM or to receive paging information. The processor 702 enables the SIM 704 to enter an in-active state in response to the SIM 704 not needing to perform the RRM or to receive the paging information, and the SIM 706 not being at OOS. The processor 702 enables the SIM 704 to enter an assist-OOS search state to perform the PLMN searches in response to the SIM 706 intending to perform the OOS recovery and the SIM 704 being about to enter the in-active state.

In some embodiments, in response to the operators of the SIM 704 and the SIM 706 not being the same and the service type of the SIM 704 being an RRC connected state, the processor 702 performs PLMN searches on the stored frequencies, and full-band power scan (PS) and PLMN searches on all frequencies iteratively using the SIM 706. Alternatively, the processor 702 sporadically performs RSSI sniffing on all the stored frequencies using the SIM 706. Alternatively, the processor 702 stops the OOS recovery to prevent interruption over the SIM 704 using the SIM 706.

In some embodiments, the processor 702 enables the SIM 706 to enter an active-OOS state from an initialization in response to the UE failing to establish a link with a network, and enables the SIM 706 to reset the OOS period timer to a first value and reset the OOS duration timer to a second value. The processor 702 enables the SIM 706 to enter the active-OOS state from a stop-OOS state in response to the OOS period timer expiring, and enables the SIM 706 to reset the OOS period timer to the first value and reset the OOS duration timer to the second value. The previous state before the stop-OOS state is the active-OOS state. The processor 702 enables the SIM 706 to enter the active-OOS state from a passive-OOS state in response to the passive OOS timer expiring or the RSSI sniffing indicating that some frequency's metric exceeds a threshold.

In some embodiments, the processor 702 enables the SIM 706 to enter the passive-OOS state from the active-OOS state in response to a continued failure to identify a cell to camp on even for limited service and PWS service after completing the PLMN searches on the stored frequencies and the full-band PS and PLMN searches on all frequencies. The processor 702 enables the SIM 706 to enter the passive-OOS state from the stop-OOS state in response to the OOS period timer expiring, and enables the SIM 706 to reset the OOS period timer to the first value and reset the OOS duration timer to the second value. The previous state before the stop-OOS state is the passive-OOS state.

In some embodiments, the processor 702 enables the SIM 706 to enter the stop-OOS state from the active-OOS state in response to execution of sub-functions in the active-OOS state being done and the OOS duration timer expiring with an enable duty cycle being true. The processor 702 enables the SIM 706 to enter the stop-OOS state from the passive-OOS state in response to execution of sub-functions in the passive-OOS state being done and the OOS duration timer expiring with an enable duty cycle being true.

In some embodiments, the processor 702 performs a first function to gather information from the SIM 704, checks RRC and operator combo of the SIM 704 and the SIM 706, and decides a duty cycle for the OOS recovery. The processor 702 performs a second function to optimize the OOS recovery in the different scenarios, and modifies relative parameters adaptively in the different scenarios. The processor 702 performs a third function to perform the PLMN searches.

In some embodiments, the processor 702 enables the SIM 706 to enter a registered state from the active-OOS state in response to detecting a suitable cell and being registered successfully. The processor 702 enables the SIM 706 to enter the active-OOS state from the registered state in response to losing connection to a network and failing at re-establishment in radio link failure (RLF).

In some embodiments, the processor 702 shares network information with the SIM 706 to avoid radio frequency (RF) preemption by the SIM 706 in response to the operators of the SIM 704 and the SIM 706 being the same or sharing a network, and the service type of the SIM 704 being a radio resource control (RRC) idle state or an RRC connected state.

In some embodiments, the processor 702 performs the OOS recovery using the SIM 704 to obtain a result and share the result with the SIM 706 in response to the operators of the SIM 704 and the SIM 706 being the same or sharing a network, and the service type of the SIM 704 being an OOS state.

In some embodiments, the processor 702 performs joint band searches on the stored frequencies of both the first and second SIMs with high priority in response to the operators of the SIM 704 and the SIM 706 not being the same and the service type of the SIM 704 being an OOS state. The joint band searches take both the SIMs 704 and 706 into consideration.

In some embodiments, the processor 702 only performs an OOS recovery that is capable of dual reception (DR) during the call service in response to the operators of the SIM 704 and the SIM 706 not being the same, the service type of the SIM 704 being a radio resource control (RRC) connected state, and the SIM 704 performing a call service.

In some embodiments, in response to the operators of the SIM 704 and the SIM 706 not being the same, the service type of the SIM 704 being an RRC connected state, and the SIM 704 gaming or playing video, the processor 702 decimates searches in time instead of stopping low priority RAT searches or full-band searches, and reorders a frequency list and adaptively adjusts control of the searches.

In some embodiments, the processor 702 defines a frequency among the stored frequencies that was camped on last, or measured from inter-measurement, or preference frequency, or registered public land mobile network (RPLMN) for roaming, or home PLMN (HPLMN) for roaming, or equivalent HPLMN (EHPLMN) for roaming as high priority. The processor 702 defines a frequency among the stored frequencies that is detected from a weak cell or removed from the high priority as middle priority. The processor 702 defines all other frequencies that do not belong to the high priority and middle priority as low priority.

The goal of the method for OOS recovery is not to interrupt non-OOS SIM. The method for OOS recovery is integrated for both single SIM and dual SIM. The method for OOS recovery adaptively reorders the priority in the stored frequency list and adjusts the operating frequency for different scenarios. The method for OOS recovery performs joint band search when 2 SIMs belong to different operators, and both are at OOS.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for out-of-service (OOS) recovery on user equipment (UE) having a first subscriber identity module (SIM) and a second SIM, wherein the second SIM intends to perform the OOS recovery, the method comprising:
scheduling searches for stored frequencies, full bands, and different radio access technologies (RAT) based on different scenarios and a service type of the first SIM, and
prioritizing an order of the stored frequencies, the full bands, and the RATs for the searches based on the different scenarios and the service type of the first SIM.

2. The method as claimed in claim 1, wherein the step of scheduling the searches for the stored frequencies, the full bands, and the different RATs based on different scenarios and the service type of the first SIM comprises:
in response to operators of the first SIM and the second SIM not being the same and the service type of the first SIM being a radio resource control (RRC) idle state, sporadically performing public land mobile network (PLMN) searches using the first SIM.

3. The method as claimed in claim 2, wherein the step of sporadically performing the PLMN searches using the first SIM comprises:
enabling the first SIM to enter an active state in response to the first SIM intending to perform radio resource management (RRM) or to receive paging information;
enabling the first SIM to enter an in-active state in response to the first SIM not needing to perform the RRM or to receive the paging information and the second SIM not being at OOS; and
enabling the first SIM to enter an assist-OOS search state to perform the PLMN searches in response to the second SIM intending to perform the OOS recovery and the first SIM being about to enter the in-active state.

4. The method as claimed in claim 1, wherein the step of scheduling the searches for the stored frequencies, the full bands, and the different RATs based on different scenarios and the service type of the first SIM comprises: in response to the operators of the first SIM and the second SIM not being the same and the service type of the first SIM being a radio resource control (RRC) connected state,
performing public land mobile network (PLMN) searches on the stored frequencies, and full-band power scan (PS) and PLMN searches on all frequencies iteratively using the second SIM; or
sporadically performing received signal strength indication (RSSI) sniffing on all the stored frequencies using the second SIM; or
stopping the OOS recovery to prevent interruption over the first SIM using the second SIM.

5. The method as claimed in claim 4, wherein the step of performing the PLMN searches on the stored frequencies, and the full-band PS and PLMN searches on all frequencies iteratively using the second SIM, comprises:
enabling the second SIM to enter an active-OOS state from an initialization in response to the UE failing to establish a link with a network, and enabling the second SIM to reset an OOS period timer to a first value and reset an OOS duration timer to a second value;
enabling the second SIM to enter the active-OOS state from a stop-OOS state in response to the OOS period timer expiring, and enabling the second SIM to reset the OOS period timer to the first value and reset the OOS duration timer to the second value; wherein a previous state before the stop-OOS state is the active-OOS state; and
enabling the second SIM to enter the active-OOS state from a passive-OOS state in response to a passive OOS timer expiring or the RSSI sniffing indicating that some frequency's metric exceeds a threshold.

6. The method as claimed in claim 5, wherein the step of sporadically performing the RSSI sniffing on all the stored frequencies using the second SIM comprises:
enabling the second SIM to enter the passive-OOS state from the active-OOS state in response to a continued failure to identify a cell to camp on even for limited service and public warning system (PWS) service after completing the PLMN searches on the stored frequencies and the full-band PS and PLMN searches on all frequencies; and
enabling the second SIM to enter the passive-OOS state from the stop-OOS state in response to the OOS period timer expiring, and enabling the second SIM to reset the OOS period timer to the first value and reset the OOS duration timer to the second value; wherein the previous state before the stop-OOS state is the passive-OOS state.

7. The method as claimed in claim 6, wherein the step of stopping the OOS recovery to prevent interruption over the first SIM using the second SIM comprises:
enabling the second SIM to enter the stop-OOS state from the active-OOS state in response to execution of sub-functions in the active-OOS state being done and the OOS duration timer expiring with an enable duty cycle being true; and
enabling the second SIM to enter the stop-OOS state from the passive-OOS state in response to execution of sub-functions in the passive-OOS state being done and the OOS duration timer expiring with an enable duty cycle being true.

8. The method as claimed in claim 4, wherein the step of performing the PLMN searches on the stored frequencies, and the full-band PS and PLMN searches on all frequencies iteratively using the second SIM comprises:
performing a first function to gather information from the first SIM, check RRC and operator combo of the first SIM and the second SIM, and decide a duty cycle for the OOS recovery;
performing a second function to optimize the OOS recovery in the different scenarios, and modify relative parameters adaptively in the different scenarios; and
performing a third function to perform the PLMN searches.

9. The method as claimed in claim 5, further comprising:
enabling the second SIM to enter a registered state from the active-OOS state in response to detecting a suitable cell and being registered successfully; and
enabling the second SIM to enter the active-OOS state from the registered state in response to losing connection to a network and failing at re-establishment in radio link failure (RLF).

10. The method as claimed in claim 1, wherein the step of scheduling the searches for the stored frequencies, the full bands, and the different RATs based on different scenarios and the service type of the first SIM comprises:
in response to the operators of the first SIM and the second SIM being the same or sharing a network, and the service type of the first SIM being a radio resource control (RRC) idle state or an RRC connected state, sharing network information with the second SIM to avoid radio frequency (RF) preemption by the second SIM.

11. The method as claimed in claim 1, wherein the step of scheduling the searches for the stored frequencies, the full bands, and the different RATs based on different scenarios and the service type of the first SIM comprises:
in response to the operators of the first SIM and the second SIM being the same or sharing a network, and the service type of the first SIM being an OOS state, performing the OOS recovery using the first SIM to obtain a result, and sharing the result with the second SIM.

12. The method as claimed in claim 1, wherein the step of scheduling the searches for the stored frequencies, the full bands, and the different RATs based on different scenarios and the service type of the first SIM comprises:
in response to the operators of the first SIM and the second SIM not being the same and the service type of the first SIM being an OOS state, performing joint band searches on the stored frequencies of both the first and second SIMs with highest priority; wherein the joint band searches take both the first and second SIMs into consideration.

13. The method as claimed in claim 1, wherein the step of scheduling the searches for the stored frequencies, the full bands, and the different RATs based on different scenarios and the service type of the first SIM comprises:
in response to the operators of the first SIM and the second SIM not being the same, the service type of the first SIM being a radio resource control (RRC) connected state, and the first SIM performing a call service, only performing an OOS recovery that is capable of dual reception (DR) during the call service.

14. The method as claimed in claim 1, wherein the step of scheduling the searches for the stored frequencies, the full bands, and the different RATs based on different scenarios and the service type of the first SIM comprises: in response to the operators of the first SIM and the second SIM not being the same, the service type of the first SIM being a radio resource control (RRC) connected state, and the first SIM gaming or playing video,
decimating searches in time instead of stopping low priority RAT searches or full-band searches, and
reordering a frequency list and adaptively adjusting control of the searches.

15. The method as claimed in claim 1, wherein the step of prioritizing the order of the stored frequencies, the full bands, and the RATs for the searches based on the different scenarios and the service type of the first SIM comprises:
defining a frequency among the stored frequencies that was camped on last, or measured from inter-measurement, or preference frequency, or registered public land mobile network (RPLMN) for roaming, or home PLMN (HPLMN) for roaming, or equivalent HPLMN (EHPLMN) for roaming as high priority;
defining a frequency among the stored frequencies that is detected from a weak cell or removed from the high priority as middle priority; and
defining all other frequencies that do not belong to the high priority and middle priority as low priority.

16. A user equipment, comprising:
a first subscriber identity module (SIM);
a second SIM, intending to perform the OOS recovery; and
a processor, electrically coupled the first SIM and the second SIM, and configured to:
schedule searches for stored frequencies, full bands, and different radio access technologies (RAT) based on different scenarios and the service type of the first SIM, and
prioritize the order of the stored frequencies, the full bands, and the RATs for the searches based on the different scenarios and the service type of the first SIM.

17. The UE as claimed in claim 16, wherein in response to the operators of the first SIM and the second SIM not being the same and the service type of the first SIM being a radio resource control (RRC) idle state, the processor is configured to sporadically perform public land mobile network (PLMN) searches using the first SIM.

18. The UE as claimed in claim 17, wherein the processor is configured to:
enable the first SIM to enter an active state in response to the first SIM intending to perform radio resource management (RRM) or to receive paging information,
enable the first SIM to enter an in-active state in response to the first SIM not needing to perform the RRM or to receive the paging information and the second SIM not being at OOS, and
enable the first SIM to enter an assist-OOS search state to perform the PLMN searches in response to the second SIM intending to perform the OOS recovery and the first SIM being about to enter the in-active state.

19. The UE as claimed in claim 16, wherein in response to the operators of the first SIM and the second SIM not being the same and the service type of the first SIM being a radio resource control (RRC) connected state, the processor is configured to:
perform public land mobile network (PLMN) searches on the stored frequencies, and full-band power scan (PS) and PLMN searches on all frequencies iteratively using the second SIM; or
sporadically perform received signal strength indication (RSSI) sniffing on all the stored frequencies using the second SIM; or
stop the OOS recovery to prevent interruption over the first SIM using the second SIM.

20. The UE as claimed in claim 19, wherein the processor is configured to:
enable the second SIM to enter an active-OOS state from an initialization in response to the UE failing to establish a link with a network, and enable the second SIM to reset the OOS period timer to a first value and reset the OOS duration timer to a second value;
enable the second SIM to enter the active-OOS state from a stop-OOS state in response to the OOS period timer expiring, and enable the second SIM to reset the OOS period timer to the first value and reset the OOS duration timer to the second value; wherein the previous state before the stop-OOS state is the active-OOS state; and
enable the second SIM to enter the active-OOS state from a passive-OOS state in response to the passive OOS timer expiring or the RSSI sniffing indicating that some frequency's metric exceeds a threshold.

21. The UE as claimed in claim 20, wherein the processor is configured to:
enable the second SIM to enter the passive-OOS state from the active-OOS state in response to a continued failure to identify a cell to camp on even for limited service and public warning system (PWS) service after completing the PLMN searches on the stored frequencies and the full-band PS and PLMN searches on all frequencies; and
enable the second SIM to enter the passive-OOS state from the stop-OOS state in response to the OOS period timer expiring, and enable the second SIM to reset the OOS period timer to the first value and reset the OOS duration timer to the second value; wherein the previous state before the stop-OOS state is the passive-OOS state.

22. The UE as claimed in claim 21, wherein the processor is configured to:
enable the second SIM to enter the stop-OOS state from the active-OOS state in response to execution of sub-functions in the active-OOS state being done and the OOS duration timer expiring with an enable duty cycle being true; and
enable the second SIM to enter the stop-OOS state from the passive-OOS state in response to execution of sub-functions in the passive-OOS state being done and the OOS duration timer expiring with an enable duty cycle being true.

23. The UE as claimed in claim 19, wherein the processor is configured to:
perform a first function to gather information from the first SIM, check RRC and operator combo of the first SIM and the second SIM, and decide a duty cycle for the OOS recovery;
perform a second function to optimize the OOS recovery in the different scenarios, and modify relative parameters adaptively in the different scenarios; and
perform a third function to perform the PLMN searches.

24. The UE as claimed in claim 20, wherein the processor is configured to:
enable the second SIM to enter a registered state from the active-OOS state in response to detecting a suitable cell and being registered successfully; and
enable the second SIM to enter the active-OOS state from the registered state in response to losing connection to a network and failing at re-establishment in radio link failure (RLF).

25. The UE as claimed in claim 16, wherein the processor is configured to:
share network information with the second SIM to avoid radio frequency (RF) preemption by the second SIM in response to the operators of the first SIM and the second SIM being the same or sharing a network, and the service type of the first SIM being a radio resource control (RRC) idle state or an RRC connected state.

26. The UE as claimed in claim 16, wherein the processor is configured to:
perform the OOS recovery using the first SIM to obtain a result and share the result with the second SIM in response to the operators of the first SIM and the second SIM being the same or sharing a network, and the service type of the first SIM being an OOS state.

27. The UE as claimed in claim 16, wherein the processor is configured to:
perform joint band searches on the stored frequencies of both the first and second SIMs with high priority in response to the operators of the first SIM and the second SIM not being the same and the service type of the first SIM being an OOS state; wherein the joint band searches take both the first and second SIMs into consideration.

28. The UE as claimed in claim 16, wherein the processor is configured to:
only performing an OOS recovery that is capable of dual reception (DR) during the call service in response to the operators of the first SIM and the second SIM not being the same, the service type of the first SIM being a radio resource control (RRC) connected state, and the first SIM performing a call service.

29. The UE as claimed in claim 16, wherein in response to the operators of the first SIM and the second SIM not being the same, the service type of the first SIM being a radio resource control (RRC) connected state, and the first SIM gaming or playing video, the processor is configured to:
decimate searches in time instead of stopping low priority RAT searches or full-band searches; and
reorder a frequency list and adaptively adjust control of the searches.

30. The UE as claimed in claim 16, wherein the processor is configured to:
define a frequency among the stored frequencies that was camped on last, or measured from inter-measurement, or preference frequency, or registered public land mobile network (RPLMN) for roaming, or home PLMN (HPLMN) for roaming, or equivalent HPLMN (EHPLMN) for roaming as high priority;
define a frequency among the stored frequencies that is detected from a weak cell or removed from the high priority as middle priority; and
define all other frequencies that do not belong to the high priority and middle priority as low priority.
